(19) United States
(12) Patent Application Publication
(10) Pub. No.: US 2023/0182451 A1
(43) Pub. Date: Jun. 15, 2023

(54) METHOD FOR THE PRODUCTION OF A PRINTED LAMINATED GLAZING

(71) Applicant: SAINT-GOBAIN GLASS FRANCE, COURBEVOIE (FR)

(72) Inventors: Manuel GOUBET, LE PLESSIS-BRION (FR); Laurent CARDINAL, MACHEMONT (FR); Thierry DUMENIL, MARGNY LES COMPIEGNE (FR); Dominique BURELOUX, OGNES (FR)

(21) Appl. No.: 17/926,057

(22) PCT Filed: May 6, 2021
(86) PCT No.: PCT/FR2021/050777

§ 371 Date: Nov. 17, 2022

(30) Foreign Application Priority Data
May 18, 2020 (FR) 2004960

(51) Int. Cl. B32B 17/10; B32B 7/12; B32B 27/08; B32B 27/30

(52) U.S. Cl. CPC B32B 17/10935; B32B 7/12; B32B 17/10275; B32B 17/10036; B32B 17/10761; B32B 27/08; B32B 27/30; B32B 2307/412; B32B 2307/538; B32B 2255/10; B32B 2605/006; B32B 2419/00; B32B 2457/12; B32B 2307/4023; B32B 2255/26

(57) ABSTRACT

A method for manufacturing a printed laminated glazing including at least one transparent sheet bonded to an adhesive interlayer, wherein the adhesive interlayer is obtained from at least a first and a second partial adhesive interlayers, wherein one of the two main faces of the first or the second partial adhesive interlayer is printed with an ink, wherein the transparent sheet, the first and the second partial adhesive interlayers are joined so that the printed main face of the first or the second partial adhesive interlayer is in direct contact with the second or the first partial adhesive interlayer, then the lamination is carried out.

The invention relates to the field of laminated glazing, comprising
at least one sheet of mineral glass such as soda-lime, aluminosilicate, borosilicate, possibly thermally tempered or chemically strengthened, or of transparent polymer material such as polycarbonate (PC), poly(methyl methacrylate) (PMMA), and
at least one adhesive interlayer such as polyvinyl butyral (PVB), thermoplastic polyurethane (TPU), ethylene vinyl acetate copolymer (EVA). A common example is a laminated glazing consisting of two sheets of soda-lime glass or other glass bonded together with an intermediate layer of PVB. Such a glazing is used, for example, as a motor vehicle windshield or the like, which can include numerous features: a solar radiation reflecting layer, allowing the temperature of the dashboard and the ambient temperature in the passenger compartment to be lowered, a support for an interior rear-view mirror, busbars for supplying electrical current, in particular for an indium tin oxide (ITO) layer or a network of heating wires, an upper strip filtering solar radiation, possibly with a degraded color, a rain sensor, etc. Laminated glazings are thus printed for a variety of purposes: the edge of the pane is opaque around its entire periphery to protect the underlying adhesive from UV radiation and to hide body parts or seals from the view of an observer outside the vehicle, inscriptions relating to the manufacturer, various standards, an opaque surface to hide the base of the interior mirror from the view of an observer outside the vehicle.

Laminated glazings are frequently curved, but it is usual to perform the above-mentioned printing on flat glass sheets, i.e. before curving operations, because the difficulty of printing on curved surfaces is much greater. The enamel or ink printing must meet the required optical qualities: good coverage, opacity and resolution.

Screen-printing on flat glass sheets is frequently used, but it is not without its shortcomings. In a two-sheet glass laminate, the enamel is screen-printed on the internal face of the glass sheet intended to be in the external position, that is the one in contact with the atmosphere, known as face 2, and/or on the external face of the internal glass sheet, known as face 4, which is in contact with the internal atmosphere, in particular of the passenger compartment of a transport vehicle (sometimes also on face 3, that is the internal face of this internal glass sheet).

The disadvantages of the enameling on face 2 and on face 3, which are internal in the structure of the assembled laminate, can be described as follows. The glass sheets during their bending, two by two, come into physical contact with each other despite the presence of powdery interlayers, or with mechanical elements of the bending installations. This physical contact requires the prior use of an additional oven for annealing the printing composition, in order to prevent the insufficiently hardened and dried printed surfaces from being affected: sticking of the two glass sheets, despite the separation due to the powdery interlayer, creation of defects on the uncured enamel surface, for example. This annealing is an additional step in the process that generates an additional cost on the production line.

In the enameling of the external face 4 in the structure of the assembled laminate, the firing of the enamel leads in a known way to the creation of an optical defect (in German: “Brennlinie”).

Other disadvantages common to these enamels on faces 2, 3 and 4 exist.

First of all, it is necessary to define a perfectly adapted and differentiated heating for the enameled and unenameled areas, because the enamel does not absorb the same amount of heat as glass. The heating must thus be modified for each configuration of laminated glazing, windshield, with and without rain, brightness sensor. . . .

Furthermore, the optical density of the black enamel after firing is of the order of 3. Yet, optical densities slightly higher than this value may be required, which can only be achieved by increasing the thickness of the deposited enamel.

Finally, another problem with existing enameled glass substrates is the difficulty of recycling such products, especially in the manufacture of glass substrates in sheet form (glazings). Since glazings must meet numerous requirements in terms of color, light and/or energy transmission, etc., it is important that the waste glass reintroduced in crushed form (cullet) into the melting furnaces used to manufacture glazings does not disturb the glass compositions usually already present and does not result in products which do not meet the required specifications. While unenameled glass cullet can thus be reintroduced into a float glass furnace, typically at levels of the order of 20-30% by weight of the furnace charge, the enameled glass cullet, on the other hand, generally results in the appearance of undesirable residual colorations or of residual unmelted islands in the formed glass sheets. The amount of enameled glass cullet that can be reintroduced into these furnaces does not therefore exceed, in the most favorable cases, 2 to 3% by weight of the furnace charge (the enamel generally constituting 0.1 to 0.5% by weight of this glass cullet).

These problems could be solved by printing on an adhesive interlayer and no longer on a glass sheet, but in order to preserve the desired adhesion between this layer and the glass sheet, at the interface where the printing is carried out, the composition, the method and the printing conditions must be chosen carefully.

The inventors sought a way to print on curved laminated glazings that would guarantee the required specifications of the final product: compliance with customer standards and specifications, not only from a mechanical resistance and aging point of view but also from an aesthetic point of view. These include in particular:
good coverage with a low amount of pinholes that do not affect the transparency in an unacceptable way,
a required opacity corresponding to an optical density of at least 3, preferably 4, as measured by an X-Rite 341 device or equivalent,
a resolution and print appearance acceptable to the customer, that is similar to that of enameling on glass.

On the other hand, the inventors have also aimed at the possibility of using numerous printing processes such as screen printing, inkjet, offset, flexography, pad printing, digital printing, as well as numerous types of ink compositions, in order to print in all colors: black, grey, white, blue, green, red, yellow, etc. . . .

These aims have been achieved by the invention which, consequently, has as its object a method for manufacturing a printed laminated glazing comprising at least one transparent sheet bonded to an adhesive interlayer, characterized in that the adhesive interlayer is obtained from at least a first and a second partial adhesive interlayer, in that one of the two main faces of the first or second partial adhesive interlayer is printed with an ink, in that the transparent sheet and the first and second partial adhesive interlayers are joined so that the printed main face of the first or second partial adhesive interlayer is in direct contact with the second or first partial adhesive interlayer, and then in that lamination is carried out.

The invention makes it possible to replace the enameling of mineral glass sheets mentioned above, and thus to eliminate the enamel pre-firing operation, by solving the problems inherent in this latter, such as the optical defects of enameling on face 4, and those linked to the different thermal conductivity of the enamel and of the glass. However, it must be emphasized that such enameling, particularly on faces 2, 4 and/or 3 in the case of a laminate with two sheets of glass, does not systematically exclude the glazing from the scope of the invention.

The combined thickness of the two partial adhesive layers can be equal to the usual thickness of one adhesive layer, leaving the area density of the laminated glazing unchanged.

The ink is protected within the adhesive interlayer.

The adhesion between the transparent glass or other sheet and the adhesive interlayer is increased with respect to a laminate having ink printing at the interface thereof; in a two-sheet glass laminate, the adhesion between them is therefore increased.

The acid resistance of the printed laminated glazing is improved.

In the manufacture of laminated glazings, the invention allows the storage of assemblies of two partial adhesive interlayers, one of which is printed, one on top of the other, thus saving space. The invention makes it possible to use only unprinted transparent sheets in combination with assemblies of possibly differently printed partial adhesive layers, thus facilitating the storage and supply of transparent sheets in the production process. This means that the components of the printed laminated glazing are easily available for production, at any time.

The invention makes it possible to print on the edge of the laminated glazing. (By contrast, the application of an enamel on the surface of the glass requires a non-enameled area of at least 2 mm around the edge of the glass, to guarantee good degassing during the assembly stage and avoid delamination, to avoid the problem of breakage in the furnace linked to the presence of enamel on the shaping joint, and also because the printing technology does not allow printing on the edge of the glass.)

The printed laminated glazing obtained by the method of the invention may consist of only one transparent sheet and an adhesive interlayer, or of two transparent sheets bonded via an adhesive layer, or even of at least three transparent sheets bonded in pairs by an adhesive interlayer (that is n transparent sheets and (n−1) adhesive interlayers). In the latter case, a plurality of such adhesive interlayers may each consist of two partial adhesive interlayers carrying an ink printing on an inner main face of one of the two, in accordance with, and without departing from, the scope of the invention. Such a printing according to the invention in two different planes of the laminated structure can produce a visual relief effect.

Preferably, a first and a second transparent sheet are bonded via the adhesive interlayer.

Preferably, the transparent sheet or sheets are, each independently of the other, made of mineral glass of the soda-lime, aluminosilicate, borosilicate or equivalent type, possibly thermally tempered or chemically reinforced, or of a polymer material such as polycarbonate (PC), poly(methyl methacrylate) (PMMA), polyurethane (PU) or equivalent.

Preferably, the first and second partial adhesive interlayers, as well as any other adhesive interlayer which may form part of the printed laminated glazing are, each independently of the other, made of polyvinyl butyral (PVB), ethylene vinyl acetate (EVA), thermoplastic polyurethane (TPU) or the like.

Preferably, at least the two main faces of the first and second partial adhesive interlayers in direct contact with each other have a roughness between 2.80 and 4.20 μm. During printing, the ink does not completely fill the valleys formed by this roughness of the substrate on which it is deposited. The two main faces of each of the first and second partial adhesive interlayers, as well as of any other adhesive interlayer possibly used in the manufacture of the laminated glazing, may, moreover, have a roughness of between 2.80 and 4.20 μm, this arrangement being favorable to good degassing during the assembly stage.

Preferably, one of the two main faces of the first or second partial adhesive interlayer is subjected to oxidation by plasma flaming, corona discharge or the like prior to being printed. The adhesive interlayer surface thus treated is activated so that it is compatible with printing by all types of inks.

Preferably, one of the two main faces of the first or the second partial adhesive interlayer is printed by screen printing, inkjet, offset, flexography, pad printing, digital printing or the like.

Preferably, one of the two main faces of the printed first or second partial adhesive interlayer is dried before the first and second partial adhesive interlayers are joined to the transparent sheet and in direct contact with each other. For example, natural drying, using forced air, optionally simultaneously with polymerization, such as assisted by ultraviolet radiation.

Preferably, at least one of the two main faces of at least one transparent sheet, the main face internal to the structure of the printed laminated glazing, that is not exposed to the outside (external atmosphere, passenger compartment of a motor vehicle, for example) is printed by screen printing, inkjet, offset, flexography, pad printing, digital printing or the like, with the same ink as one of the two main faces of the first or second partial adhesive interlayer. In a laminated glazing with two glass sheets, these are faces 2 and/or 3.

Another object of the invention is the application of a printed laminated glazing obtained by the method described above, as an automotive glazing such as a windshield, a glazing for building construction, solar energy, or industry.

The invention is illustrated by the following example.

### EXAMPLE

Two 0.38 mm thick PVB partial adhesive layers, marketed by Eastman under the registered trademark Saflex® RB11, are used, with the two main faces thereof having a roughness of between 2.85 and 4.18 μm.

One face of one of these two partial layers is screen-printed.

The ink is mixed for 30 minutes, its viscosity is measured, a thinner is added if the viscosity is not in compliance, and then the ink is mixed for 30 minutes before being applied to the screen-printing screen.

The screen-printing is done on the PVB sheet.

Inks of different compositions and colors are used.

The ink is dried and then the partial layer of PVB is joined to the second partial layer of unprinted PVB so that the print is at the interface of the two partial layers. Then a conventional assembly is carried out (deaeration through setting under vacuum, subjecting to a rise in temperature, pressure) of the two partial layers of PVB to two sheets of soda-lime float glass. A laminated glazing of high mechanical quality and colored printing of high optical quality as described above is obtained. The “dry to touch” time of 10 minutes is short and compatible with an industrial continuous line process.

A black ink with the composition detailed in the table below is used, wherein all proportions are given in percentages by weight.

TABLE 1

| | | | MIN AND |
|---|---|---|---|
| | | % BY | MAX % |
| COMPONENT | CAS NO. | WEIGHT | BY MASS |
| POLYVINYL BUTYRAL | 63148-65-2 | 12 | 11/13 |
| WETTING AGENT | 27987-25-3 | 8 | 5/10 |
| CARBON BLACK | 133386-4 | 9 | 8/12 |
| BLACK IRON OXIDE | 1317-61-9 | 28 | 28/32 |
| DIESTER | 627-93-0 | 38 | 35/40 |
| | 1119-40-0 | | |
| | 106-65-0 | | |
| CYCLOHEXANONE | 108-94-1 | 4 | 3/5 |
| SURFACE TENSION | 26376-86-3 | 1 | 0.5/2 |
| MODIFIER | | | |

The [OH] content of polyvinyl butyral corresponds to a polyvinyl alcohol weight percentage of 18%.

The wetting agent also acts as a plasticizer, i.e. it allows greater deformation of the printed ink film without impairing its optical properties. In this case it is dimethylcyclohexyl phthalate.

The specific surface area of carbon black is 65 m²/g, with values of 40 to 150 m²/g being generally suitable.

The diester is a mixture of 60% by weight of dimethyl glutarate, 20% by weight of dimethyl succinate and 20% by weight of dimethyl adipate.

The surface tension modifier is a 2-ethylhexyl acrylate copolymer; it does not contain silicone.

The Brookfield viscosity of the ink at 20° C. is 11 Pa·s, with values between 9 and 13 Pa·s being suitable for the purpose of the invention. This measurement is done in the following manner. The viscosity of the ink is reduced to a stable value by rotating a roller in the ink for at least 8 hours. A sample of the latter is taken, on which the viscosity is measured using a planar cone viscometer.

Under the same conditions as the black print hereinbefore, a grey print is made using an ink of the composition described in the table below.

TABLE 2

| | | | MIN AND |
|---|---|---|---|
| | | % BY | MAX % |
| COMPONENT | CAS NO. | WEIGHT | BY MASS |
| POLYVINYL BUTYRAL | 63148-65-2 | 13 | 10/15 |
| WETTING AGENT | 27987-25-3 | 9.5 | 5/12 |
| CARBON BLACK | 133386-4 | 1.5 | 0.5/3 |
| RUTILE TITANIUM | 1317-80-2 | 36 | 32/42 |
| DIOXIDE | | | |
| DIESTER | 627-93-0 | 23 | 16/45 |
| | 1119-40-0 | | |
| | 106-65-0 | | |
| GLYCOL DIETHER | 112-49-2 | 16 | 0/22 |
| SOLVENT | | | |
| SURFACE TENSION | 26376-86-3 | 1 | 0.5/2 |
| MODIFIER | | | |

The glycol diether solvent is triethylene glycol dimethyl ether.

Prints in any other color are obtained by introducing pigments, dyes or luminophores into the hereinbefore grey ink.

The pigments, defined in particular by their CAS (Chemical Abstracts Service, American Chemical Society) and CI (Color Index) numbers, can be chosen from the table below.

TABLE 3

| Pigments | CAS NO. | CI NO. |
|---|---|---|
| Yellow 13 | 13515-40-7 | Yellow 13 |
| Monoazo yellow | 6486-23-3 | Yellow 3 |
| Benzimidazolone yellow | 31837-42-0 | Yellow 151 |
| Monoazo yellow | 12225-18-2 | Yellow 97 |
| Quinacridone Rose | 980-26-7 | Red 122 |
| Quinacridone Violet | 1047-16-1 | Violet 19 |
| Dioxazine Violet | 6358-30-1 | Violet 23 |
| Carbon black | 1333-86-4 | Black 7 |
| Black iron oxide | 1317-61-9 | |
| Phthalocyanine blue | 147-14-8 | Blue 15.3 |
| Phthalocyanine green | 2786-76-7 | Green 7 |
| Titanium dioxide | 13463-67-7 | |

Dyes which can be used in the context of the invention, defined by their type and CI number, are the following.

TABLE 4

| Dyes | Type | CI NO. |
|---|---|---|
| Yellow | Cr complex | Yellow 88 |
| Yellow | Co complex | Yellow 25 |
| Orange | Co complex | Orange 11 |
| Brown | Cr complex | Brown 43 |
| Red | Cr complex | Red 130 |
| Red | Cr complex | Red 122 |
| Blue | Cu - phthalocyanine | Blue 136 |
| Blue | Cu - phthalocyanine | Blue 70 |
| Black | Cr complex | Black 29 |

As examples of luminophores, the following can be used, defined by their formula.

TABLE 5

| Luminophores | Formula |
|---|---|
| Green | Zn₂SiO₄:Mn |
| Blue | BaMgAl₁₀O₁₇:Eu |
| Yellow | Y₂₀₂S:Eu, Sm + BaMgAl₁₀O₁₇ |
| Yellow | Beta Quinophthalone |
| Red | Y₂O₃:Eu |
| Red | Y₂O₂S:Eu |

Oxidation of the PVB substrate prior to printing, such as by plasma flaming, promotes this printing.

All solvent-based inks other than PVB binder (resin), such as epoxy ink, nitrocellulose, polyamide, polyvinyl chloride, and polyurethane, among others, can be used for screen-printing, and all other printing processes: inkjet, offset, flexography, pad printing, digital printing.

The method of the invention makes it possible to easily obtain
good coverage with a low amount of pinholes that do not affect the transparency in an unacceptable way;
a required opacity corresponding to an optical density of at least 3, or 4 as required, as measured by an X-Rite 341 instrument;
a resolution and a printing aspect of qualities similar to that of enameling on glass.

The printed laminated glazing produced by the method of the invention allows it to successfully pass the following tests
boil tests of varying application conditions under national/regional regulations, according to the automotive standard R43;
bake tests of varying application conditions under national/regional regulations, according to the automotive standard R43;
heat and moisture resistance of the glazing after H14 aging according to the automotive standard DV471167; and
resistance to aging in severe BF climatic cycles in accordance with the DV471309 automotive standard.

1. A method for manufacturing a printed laminated glazing comprising at least one transparent sheet bonded to an adhesive interlayer, the method comprising:
obtaining the adhesive interlayer from at least a first and a second partial adhesive interlayers;
printing one of two main faces of the first or second partial adhesive interlayer with an ink;
joining the transparent sheet, the first and second partial adhesive interlayers so that the printed main face of the first or the second partial adhesive interlayer is in direct contact with the second or the first partial adhesive interlayer, and then
laminating the transparent sheet, the first and second partial adhesive interlayers.

2. The method according to claim 1, wherein a first and a second transparent sheets are bonded via the adhesive interlayer.

3. The method according to claim 1, wherein the transparent sheet or sheets are, each independently of the other, made of mineral glass of soda-lime, aluminosilicate, or borosilicate or of a polymer material.

4. The method according to claim 1, wherein the first and the second partial adhesive interlayers, as well as any other adhesive interlayer which forms part of the printed laminated glazing are, each independently of the other, made of polyvinyl butyral (PVB), ethylene vinyl acetate (EVA), or thermoplastic polyurethane (TPU).

5. The method according to claim 1, wherein at least the two main faces of the first and one second partial adhesive interlayers in direct contact with each other have a roughness between 2.80 and 4.20 μm.

6. The method according to claim 1, wherein one of the two main faces of the first or the second partial adhesive interlayer is subjected to oxidation by plasma flaming, or corona discharge, prior to being printed.

7. The method according to claim 1, wherein one of the two main faces of the first or the second partial adhesive interlayer is printed by screen printing, inkjet, offset, flexography, pad printing, or digital printing.

8. The method according to claim 1, wherein one of the two main faces of the printed first or second partial adhesive interlayer is dried before the first and second partial adhesive interlayers are joined to the transparent sheet and in direct contact with each other.

9. The method according to claim 1, wherein at least one of the two main faces of at least one transparent sheet, the main face internal to the structure of the printed laminated glazing, that is not exposed to the outside, is printed by screen-printing, inkjet, offset, flexography, pad printing, or digital printing, with the same ink as one of the two main faces of the first or the second partial adhesive interlayer.

10. The method according to claim 1, wherein the printed laminated glazing is an automotive glazing, a glazing for building construction, solar energy or industry.

11. The method according to claim 3, wherein the transparent sheet or sheets made of mineral glass of the soda-lime, aluminosilicate, borosilicate are thermally tempered or chemically reinforced and the polymer material is polycarbonate (PC), poly(methyl methacrylate) (PMMA), polyurethane (PU).

12. The method according to claim 10, wherein the automotive glazing is a windshield.
